(19) United States
(12) Patent Application Publication
(10) Pub. No.: US 2011/0101180 A1
(43) Pub. Date: May 5, 2011

(54) BRACKET ASSEMBLY

(75) Inventors: CHEN-RUEI TU, Tu-Cheng (TW); LI-PING CHEN, Tu-Cheng (TW)

(73) Assignee: HON HAI PRECISION INDUSTRY CO., LTD., Tu-Cheng (TW)

(21) Appl. No.: 12/719,819

(22) Filed: Mar. 8, 2010

(30) Foreign Application Priority Data
Nov. 4, 2009 (CN) 200920314031.9

(51) Int. Cl. F16M 13/00

(52) U.S. Cl. 248/200

(57) ABSTRACT

A bracket assembly includes a bracket, a handle, a positioning member, and the securing clip. The handle is attached to the bracket on a first side. The handle defines an opening. The positioning member includes a base and a post. The base abuts the second side of the bracket opposite to the first side of the bracket. The post extends through the bracket and the opening of the handle. The securing clip is attached to the post and secures the handle to the bracket. The handle is capable of pivoting about the post.

### BACKGROUND

1. Technical Field

The present disclosure relates to brackets, especially to a bracket assembly with a rotatable handle.

2. Description of Related Art

Typically mounting devices in computers and servers may use rivets or screws or other mounting components to mount hardware, such as disk drives, expansion cards, and power supplies. For example, a pivoting piece such as a bar may be used for mounting the hardware. An end of the bar is latched to a chassis, and the other end of the bar is mounted to a bracket. The hardware is secured to the bracket. However, the bar is usually mounted by rivets or nuts and bolts and is therefore difficult and inconvenient to assemble and remove.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a bracket assembly in accordance with an embodiment.

FIG. 2 is an exploded, isometric view of the bracket assembly of FIG. 1 from another aspect.

FIG. 3 is an enlarged view of a positioning member of FIG. 1.

FIG. 4 is an enlarged view of a securing clip of FIG. 1.

FIG. 5 is an assembled view of FIG. 1.

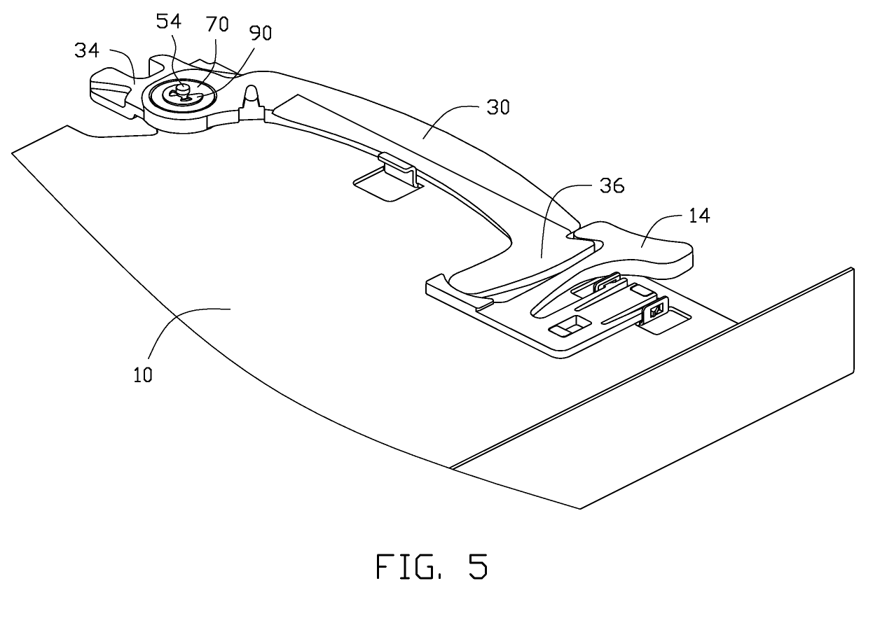

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

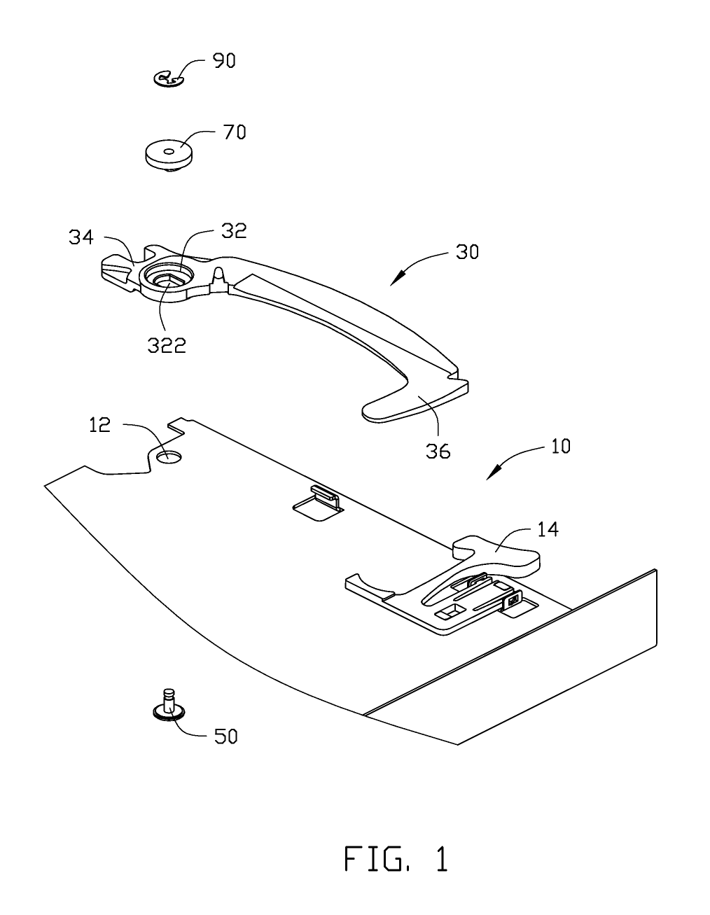

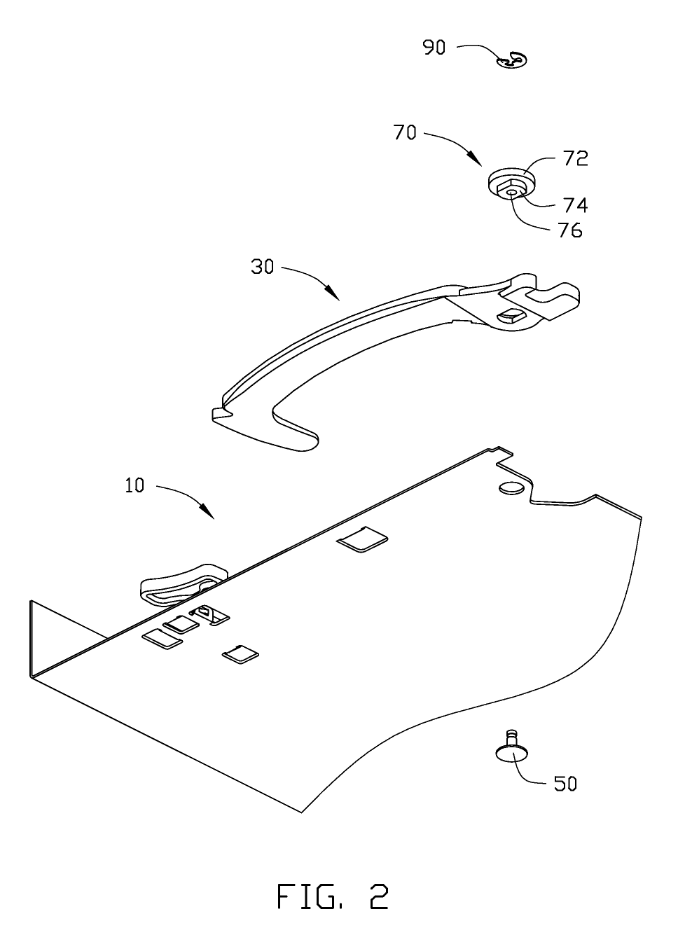

Referring to FIG. 1 and FIG. 2, a bracket assembly includes a bracket 10, a handle 30, a positioning member 50, a gasket 70, and a securing clip 90.

Referring to FIG. 1 and FIG. 2, the bracket 10 defines a top side for attaching the handle 30 and a bottom side opposite to the top side. The bracket 10 defines a securing hole 12. A latch member 14 is mounted to the bracket 10 and is a distance from the securing hole 12.

The handle 30 includes a C-shaped retaining portion 34 and a latch portion 36 opposite to the retaining portion 34. The latch portion 36 can latch with the latch member 14. The handle 30 defines a recess 32 and an opening 322. The recess 32 is placed adjacent to the retaining portion 34. The opening 322 may have a noncircular configuration.

The gasket 70 includes a body 72 and a tab 74. A pivot hole 76 is defined in the body 72 and the tab 74. The body 72 can be received in the recess 32 and the tab 74 can be engaged with the opening 322 to prevent the gasket 70 from rotating relative to the handle 10 about a pivot axis when the opening 322 is noncircular.

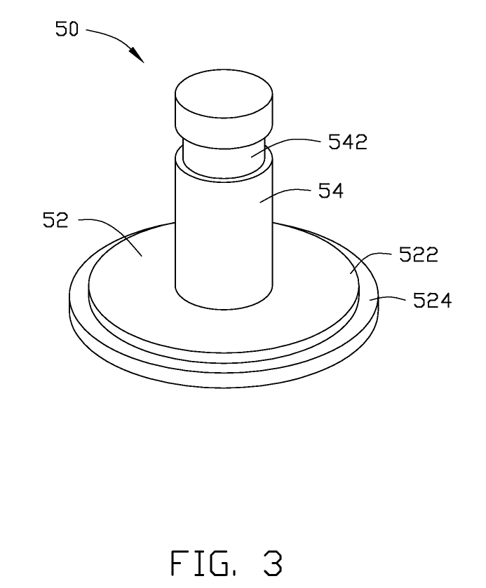

Referring to FIG. 3, the positioning member 50 includes a base 52 and a post 54. The base 52 includes a discoid insert portion 522 and a rim 524. The insert portion 522 can be just received in the securing hole 12 of the bracket 10 for steadily securing the positioning member 50 to the bracket 10. The rim 524 has a larger diameter than the securing hole 12. A circular groove 542 is defined in the post 54 for restricting the securing clip 90.

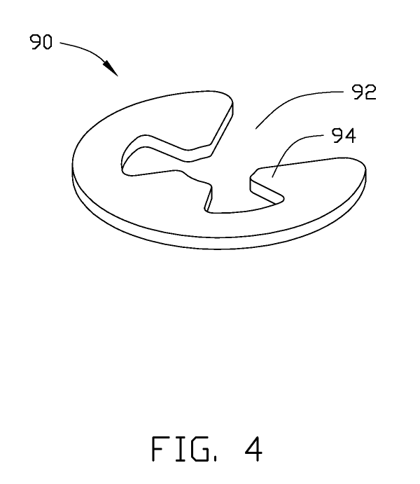

Referring to FIG. 4, the securing clip 90 can be elastically deformed when securing to the post 54. The securing clip 90 defines a cutout 92 so that the securing clip 90 can be secured to the post 54 in a direction perpendicular to the post 54. The cutout 92 has an enlarged inlet so that the securing clip 90 can be gradually deformed when the securing clip 90 is secured to the post 54. The securing clip 90 includes at a least three legs 94 facing a central portion of the securing clip 90 for abutting against the post 54.

When assembling the bracket assembly, the positioning member 50 is attached to the bracket 10 from the bottom side of the bracket 10. The handle 30 is pivotably attached to the bracket 10 about the post 54. The gasket 70 is placed in the recess 32 with the tab 74 engaged with the opening 322. The post 54 extends through the opening 322 and the gasket 70. The securing clip 90 is fixed to the post 54 within the groove 542 for retaining the handle 30 to the bracket 10.

When using the bracket assembly, the handle 30 can rotatably move towards the bracket 10 and cause the latch portion 36 to become engaged with the latch member 14. At the same time, the retaining portion 34 can secure the bracket 10 to a computer chassis (not shown). The retaining portion 34 can be released from the chassis when the latch portion 36 is released and the handle 30 moves out of the bracket 10.

It is also to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A bracket assembly comprising:
a bracket;
a handle attached to the bracket on a first side, the handle defining an opening;
a positioning member, the positioning member comprising a base and a post, the base abutting a second side of the bracket opposite to the first side of the bracket, the post extending through the bracket and the opening of the handle; and
a securing clip attached to the post and securing the handle to the bracket;
wherein the handle is capable of pivoting about the post.

2. The bracket assembly of claim 1 further comprising a gasket, wherein the gasket comprises a body, the handle further defines a recess for receiving the body, and the gasket is placed between the handle and the securing clip.

3. The bracket assembly of claim 2, wherein the opening is a noncircular shape, and the gasket further comprises a tab engaging with the opening of the handle, wherein the tab prevents the gasket from rotating relative to the handle about the post.

4. The bracket assembly of claim 1, wherein the post defines a circular groove that engages with the securing clip.

5. The bracket assembly of claim 1, wherein the securing clip defines a cutout and is secured to the post in a direction perpendicular to the post.

6. The bracket assembly of claim 5, wherein the cutout has an enlarged inlet, and the securing clip is elastically deformed when secured to the post.

7. The bracket assembly of claim 5, wherein the securing clip comprises at least three legs abutting to the post.

8. The bracket assembly of claim 1, wherein a latch member is mounted to the bracket, the latch member is capable of latching an end of the handle opposite to the opening.

9. The bracket assembly of claim 1, wherein the base comprises a discoid insert portion received in a securing hole of the bracket and an enlarged rim abutting to the second side of the bracket.

10. A bracket assembly comprising:
a bracket; and
a handle attached to the bracket on a first side, the handle defining an opening and a recess;
a gasket, the gasket comprises a body, and the body received in the recess; and
a positioning member, the positioning member comprising a base and a post, the base abutting a second side of the bracket opposite to the first side of the bracket, the post extending through the bracket and the opening of the handle and the gasket;
wherein the handle is capable of pivoting about the post.

11. The bracket assembly of claim 10, wherein the opening is a noncircular shape, and the gasket further comprises a tab engaging with the opening of the handle, wherein the tab prevents the gasket from rotating relative to the handle about the post.

12. The bracket assembly of claim 10, wherein a securing clip is attached to the post and secures the handle to the bracket;

13. The bracket assembly of claim 12, wherein the post defines a circular groove that engages with the securing clip.

14. The bracket assembly of claim 12, wherein the securing clip defines a cutout and is secured to the post in a direction perpendicular to the post.

15. The bracket assembly of claim 14, wherein the cutout has an enlarged inlet, and the securing clip is elastically deformed when secured to the post.

16. The bracket assembly of claim 14, wherein the securing clip comprises at least three legs abutting the post.

17. The bracket assembly of claim 10, wherein a latch member is mounted to the bracket, and the latch member is capable of latching an end of the handle opposite to the opening.

18. The bracket assembly of claim 10, wherein the base comprises a discoid insert portion, received in a securing hole of the bracket, and an enlarged rim abutting to the second side of the bracket.
